(19) United States
(12) Patent Application Publication
(10) Pub. No.: US 2017/0061084 A1
(43) Pub. Date: Mar. 2, 2017

(54) Health Insurance Exchange

(71) Applicant: Ashish Pandya, El Dorado Hills, CA (US)

(72) Inventor: Ashish Pandya, El Dorado Hills, CA (US)

(21) Appl. No.: 14/842,835

(22) Filed: Sep. 2, 2015

(51) Int. Cl. G06F 19/00

(52) U.S. Cl. CPC G06F 19/328

(57) ABSTRACT

A health insurance exchange is disclosed. The health insurance exchange collects health information from consumers and uses this information to derive Wellness Index Number (WIN). The WIN number of a consumer is used by insurance companies to offer health insurance plans to the consumer.

### RELATED APPLICATIONS

Priority is claimed to Provisional Application Ser. No. 62/044,420 filed on Sep. 2, 2014 entitled A Health Insurance Exchange.

### BACKGROUND

Health insurance costs for patients has been rising continuously over the past decade. There is a need to curtail the insurance costs and change trajectory of its growth as a national priority. Affordable care act is one attempt towards lowering the costs but has not been very successful so far.

### SUMMARY OF INVENTION

This patent addresses the rising cost of insurance for patients by putting patients in control of their wellness which can be used to get better insurance rates from the insurance companies. It is an objective of this patent to create first of a kind health insurance exchange where insurance companies compete with each other to acquire the patients for their network based on health information that the patient may share voluntarily. It is also an objective of this patent to create a cumulative health care wellness score (Wellness Index Number™ or WIN™ Number) for consumers that can be used as a metric by insurance companies when they compete with other insurance companies to acquire the consumers to join their network.

### DESCRIPTION OF FIGURES

FIG. 1 Illustrates a consumer's health tracking capabilities

Fig. 2 Illustrates a health insurance exchange

### DETAILED DESCRIPTION

Health insurance premiums have been growing over the years at a very high rate and is a huge cost to consumers and employers. There is a clear need to curtail the growth of health care costs and bring them down. Health and fitness awareness in the consumers is increasing but so are many chronic conditions like diabetes, blood pressure, obesity and the like which cause deterioration of a patient's health if not managed properly. Such conditions also cause the insurance premiums to rise for all insured consumers.

There is a movement amongst consumers towards better fitness habits by using mobile devices like cellular phones, smart phones, smart phone apps or wearable devices equipped with a variety of sensors for health and exercise information tracking or web and computing technologies embedded in fitness equipments. This patent application creates standardized ways of recording this health data from such mobile devices, apps, wearables, sensors and the like to create a user's health data storage facility in a secure manner on such devices or on other computing devices coupled to such devices in a network which may comprise of desktops, laptops, notebook computers, tablets, cloud computing devices, or web servers or the like or a combination of these. The user may maintain control over their health information that is being collected by such devices and deposited/stored in the health data storage.

This patent creates a capability that processes the user's health information in ways to derive a composite wellness score of the consumer. The user is able to use this capability to monitor their wellness information quickly on a regular basis without the need to get into details of various health data tracked by the devices on behalf of the user. This patent also offers the capabilities for the users to monitor in detail any aspect of their health data by allowing applications to analyze any specific information as well.

This patent creates a health insurance exchange where the consumers can join and provide their composite Wellness Index Number. This patent creates capability to secure patient's WIN number such that it is not tampered with by the consumer or any other third parties. The WIN number of the consumers is made available on the exchange where health insurance companies are members. Multiple health insurance companies are then allowed to bid to acquire the consumer to signup for one or more insurance plans that each of these health insurance company offers. Thus insurance companies get into bidding against each other with plans they individually determine to be competitive to win the insurance business from a consumer with a particular WIN number. The consumer now has a choice of plans that they can pick based on the competitive plans offered by multiple insurance companies on the health insurance network.

This patent also allows insurance companies to create incentives for consumers to improve their health by offering discounts or bonuses or rewards or the like based on how the consumer who signs up with them improves or maintains their WIN score over a period of time. Such a solution offers a win-win solution to the insurance company by keeping their clients healthy and there by avoiding expensive medical costs. On the other hand this solution offers better insurance premiums for consumers who take care of their health and fitness.

The WIN number score of this patent is derived by combining various factors of a consumers health data. This data may comprise consumer's age, weight, height, ethnicity, gender, lifestyle habits, eating habits, fitness habits, data collected from the health related sensors or the like as may be collected. The data may also comprise of their blood report laboratory values which the user may submit or may give permission to providers to submit to the exchange. The data may also comprise of the user's activities such as number of walking steps taken, aerobic workout, weight training, or other exercises which may be recorded with the time and dates. Such data may be collected on a regular basis as appropriate for the data samples. Each type of the data value that is available for any user may be aggregated using appropriate aggregation function specific for such data values. Such aggregated values (Vn) may be applied specific weights (Wn) per value and a composite WIN number score derived. Such WIN number formulae may comprise of a function such as

WIN=SUM(V1*W1+V2*W2+. . . +Vn*Wn) (1)

where WIN is the Wellness Index Number

V1, V2 through Vn are the different data values for activities or health characteristics information collected for the user

W1, W2 through Wn are corresponding weight values that are applied to such data values so as to determine a user's wellness index that may represent health risk for a user

The patent allows different insurance companies to provide weight numbers for each data value if they so desire and the health exchange would provide capabilities to organize a user's WIN number specific to any given insurance company. Insurance companies may use the WIN number generated by the health insurance exchange using preselected weights or can request the exchange to generate WIN numbers based on insurance company specific weight numbers so as to enable each insurance company to assess the user's risk based on their internal criteria. The health insurance exchange may restrict the insurance companies to use the WIN number it generates or may offer the option of customization as described above or a combination thereof without diverging from the spirit of this invention as may be appreciated by one skilled in the art.

Health insurance cost is an issue not only for consumers but also for organizations that offer health insurance to their employees. Managing the cost of insurance can have directly affect profitability of companies. It also an objective of this patent to enable companies to manage such costs by enabling organizations to become members of the health insurance exchange of this invention. Such organizations may provide incentives to their employees by offering health and fitness tracking devices where their employees may still stay to be the owners of their health data but agree to provide their WIN number for the organization's health exchange data store. The health insurance exchange of this invention then provides capabilities where WIN numbers of all registered employees of an organization are aggregated to derive an organizations composite WIN number. Organizations who are members of the health insurance exchange are then allowed by the exchange to invite bids from insurance companies. Multiple health insurance companies may now be able to offer a variety of health insurance options to the organizations at prices they determine to be competitive. The organization can in turn choose the best plans for their employees in a cost effective manner.

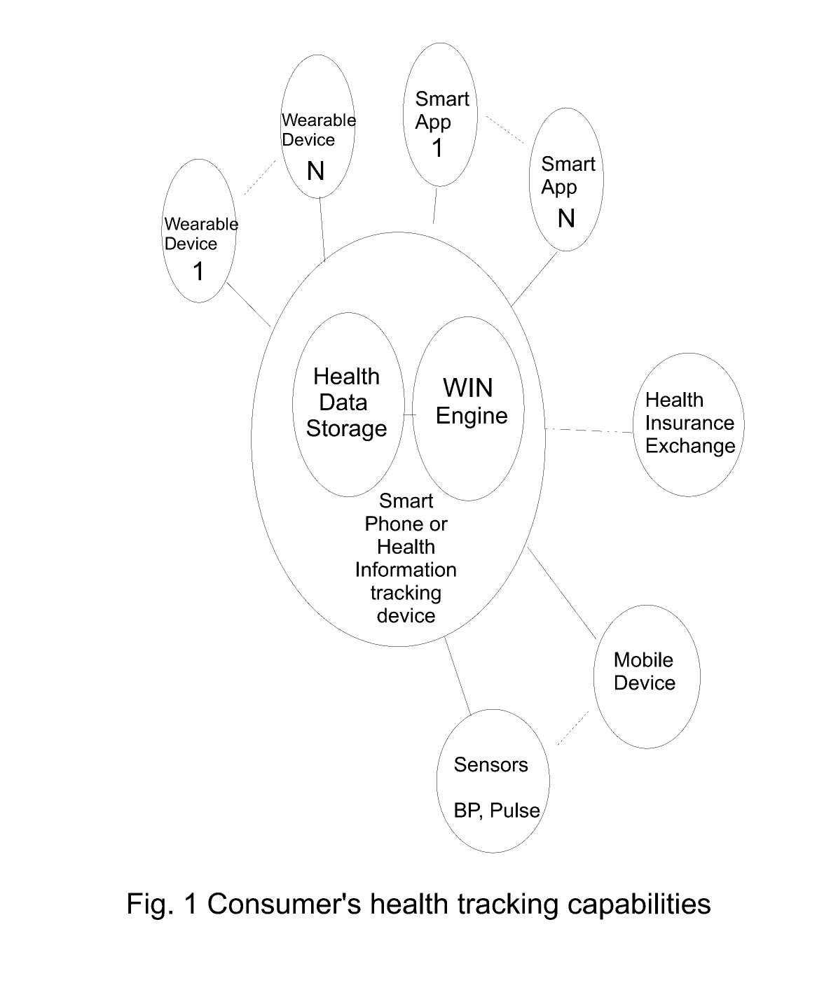

FIG. 1 illustrates a consumer's health tracking capabilities of this invention. These capabilities may comprise of wearable devices such as smart watch, blood pressure sensor, pulse monitor, accelerometer based devices, mobile phones, smart phones and the like. These devices collect specific health data of the user and record the data in a format recommended by the health insurance exchange. The data is then placed in a health data storage facility on a smart phone of the user or a data collection device provided by the health insurance exchange. This device also has a secure capability that is used to derive the WIN number using formulae similar to that in equation 1 above. This device is also coupled to the health insurance exchange to securely exchange the WIN number and associated data as may be appropriate to enable the user to participate in the health insurance exchange of this patent to get competing health insurance quotes from health insurance companies.

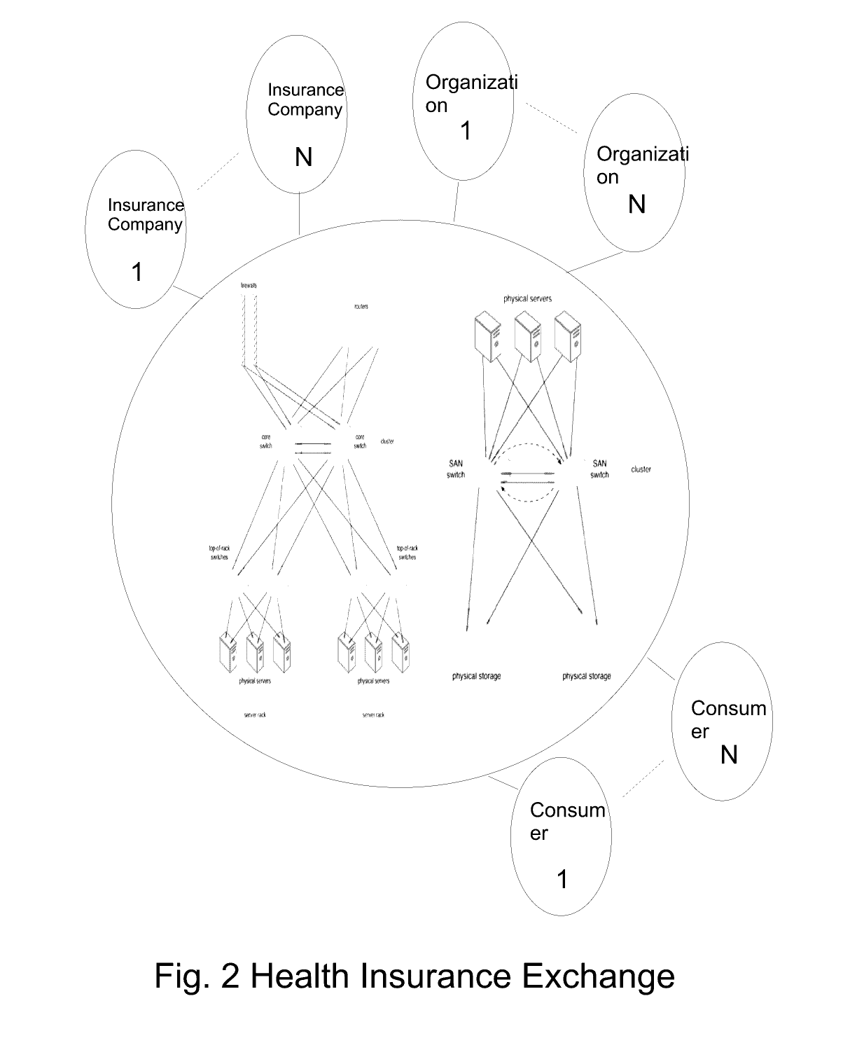

FIG. 2. illustrates a health insurance exchange of this invention. The health insurance exchange is illustrated to reside in the cloud. The insurance companies that use the health insurance exchange to provide insurance plan choices to the consumers couple to the health insurance exchange to analyze WIN information of consumers. The consumers also couple to the exchange in the cloud using their devices that hold the WIN number and the health data storage. The figure also illustrates employers coupled to the exchange information to enable their employees to become part of the exchange as well and derive competing insurance quotes for the employer organization as described above.

While the foregoing has been with reference to particular embodiments of the invention, it will be appreciated by those with ordinary skill in the art that changes in these embodiments may be made without departing from the principles and spirit of the invention. For example it is possible to organize this health insurance exchange and its associated users including the employers and insurance companies differently as well as derive WIN number by applying different methods without deviating from the teachings and the spirit of this invention as may be appreciated by those skilled in the art. All such variations are within the scope of this invention and claimed by this invention.

1. A health insurance exchange for connecting at least one health insurance company to at least one consumer where in the health insurance exchange derives a wellness index number for the said at least one consumer and the said wellness index number is used by the said at least one health insurance company to create at least one health insurance plan offer to the said at least one consumer.

2. A health insurance exchange for connecting at least one health insurance company to at least one consumer where in the health insurance exchange derives a wellness index number for the said at least one consumer by tracking up to N indicators about the consumer.

3. A health insurance exchange for connecting at least one health insurance company to at least one organization where in the health insurance exchange derives a organizational wellness index number for the said at least one organization and the said organizational wellness index number is used by the said at least one health insurance company to create at least one health insurance plan offer to the said at least one organization for the employees of the organization.
